(19) United States
(12) Patent Application Publication
(10) Pub. No.: US 2007/0117698 A1
(43) Pub. Date: May 24, 2007

(54) THERAPEUTIC DEVICE

(76) Inventor: TRENT ADAMSON, ROZELLE, NEW SOUTH WALES (AU)

Correspondence Address: CROMPTON, SEAGER & TUFTE, LLC, 1221 NICOLLET AVENUE, SUITE 800, MINNEAPOLIS, MN, 55403-2420, US

(21) Appl. No.: 11/555,775

(22) Filed: Nov. 2, 2006

(30) Foreign Application Priority Data
Nov. 3, 2005 (AU) 2005906093

(51) Int. Cl. A61H 1/00; A63B 23/00; A61H 1/02

(52) U.S. Cl. 482/148; 601/1

(57) ABSTRACT

A therapeutic device comprises a cradling portion arranged to cradle the head of a user and a pivoting arrangement which provides a pivot area spaced away from the cradling portion and which allows the cradling portion to pivot about more than one axis. In use, the user must effect a balancing action to maintain the position of their head.

### TECHNICAL FIELD

This invention relates to a therapeutic device. In use, the device cradles the head of a user.

### SUMMARY OF THE INVENTION

In a first aspect the present invention provides a therapeutic device comprising: a cradling portion arranged to cradle the head of a user; a pivoting arrangement provides a pivot area spaced away from the cradling portion and allows the cradling portion to pivot about more than one axis, such that in use the user must effect a balancing action to maintain the position of their head.

The pivot area may be spaced away from the cradling portion by a distance of 2 to 8 centimetres, but preferably by a distance of about 4 to 5 centimetres.

The pivoting arrangement may comprise a generally convex surface.

### BRIEF DESCRIPTION OF THE DRAWINGS

Embodiments of the present invention will now be described, by way of example only, with reference to the accompanying drawings, in which:

FIG. 1a is a perspective view of an embodiment of a device according to the present invention;

FIG. 1b is an illustration of a person using the therapeutic device of FIG. 1.

FIG. 2 is a perspective view showing an alternate embodiment of the device according to the present invention.

### DETAILED DESCRIPTION OF THE PREFERRED EMBODIMENTS

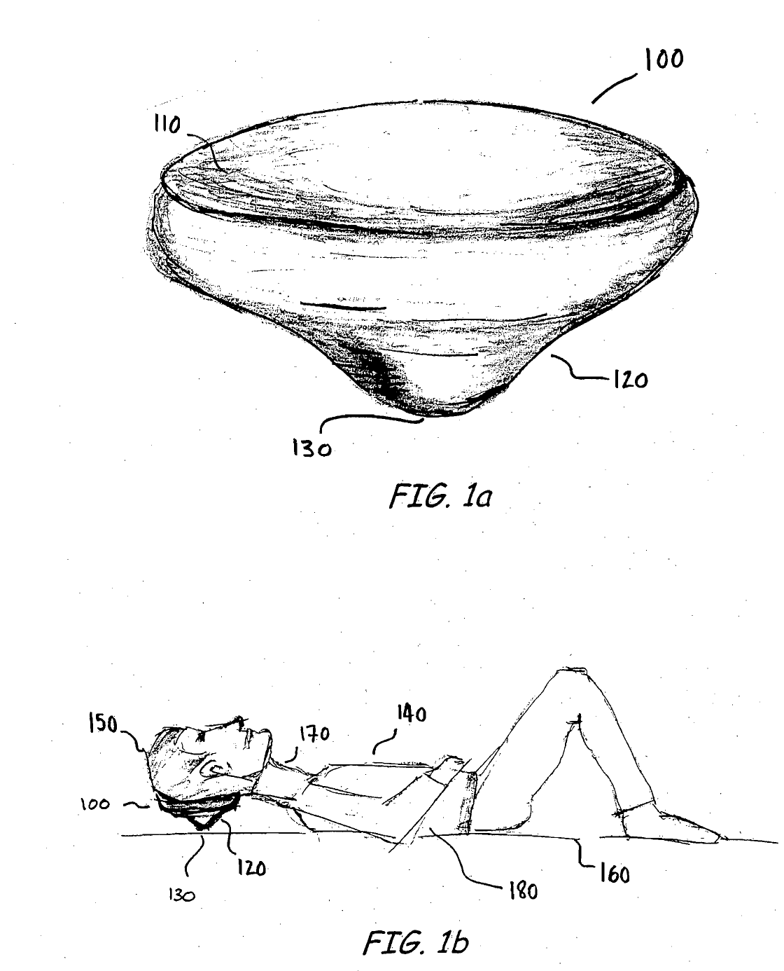

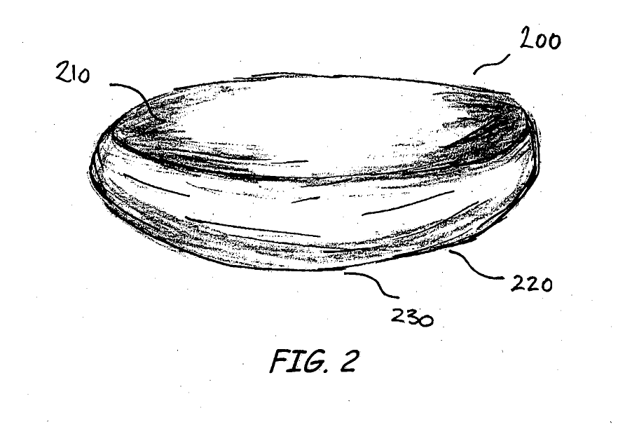

Referring to FIG. 1a, there is shown a therapeutic device 100. Device 100 comprises a cradling portion in the form of concave portion 110 contoured to comfortably receive the posterior curvature of a user's head (particularly the region immediately above the sub-occipital bone—See also FIG. 2) and a pivoting arrangement in the form of convex base 120 having a pivot area 130 for allowing the concave portion 110 to pivot about more than one axis. The pivot area 130 is spaced away from the concave portion 110 by a distance of approximately 4 centimetres.

A method for relieving muscle tension using the device 100 will now be described with reference to FIG. 1b. While lying in the semi-supine position (ie lying on the back with the knees in the upright position and the elbows on the ground and hands resting upon the iliac crest), a user 140 places the device 100 directly underneath their head 150 such that the device 100 engages the ground 160 at pivot area 130. While supporting the device 100 in an upright position, the user 140 gently lowers their head 150 until it is resting comfortably on the concave portion 110. From this point onwards, the user 140 is required to effect a delicate balancing action to prevent their head from tipping in one or more directions; for example from side to side, forwards, backwards, or a combination of the above. The balancing action engaged by the head 150 and neck 170 allows the musculature tensions that have accumulated throughout the head 150, neck 170 and back 180 to be released through head 150 and down through the sacrum (not shown). In addition, the slight raise from the horizontal encourages the user's lower back to fall into the ground, giving a flatter, freer and fuller sensation throughout the lower back and pelvic region.

Referring to FIG. 2 there is shown an alternate embodiment of the therapeutic device 200 having an alternate pivoting arrangement 220. In this embodiment, the convex curvature of the pivoting arrangement 220 is slightly less exaggerated, providing a more limited freedom of movement throughout the head 150 and neck 170, when in use. The concave portion 210 has a diameter approximately twice that of the previous embodiment, however maintains a spacing of approximately 4 centimetres between the pivot area 230 and concave portion 210.

Due to the pivoting arrangement provided by the present invention, the user is required to effect a delicate balancing action in order to maintain the position of their head, which is conducive to providing a sensation of freedom throughout the body that can then be transferred to the standing and sitting positions, and indeed through all aspects of life and human movement.

In the described embodiments the therapeutic device was made from moulded clay that had been air dried prior to use. However, it is readily appreciated that the device could be made of any hard and durable material that is rigid enough to resist distortion, for example: plastics, wood etc. In one embodiment, the therapeutic device is made of a plastic formed using injection moulding techniques.

The above described pivoting arrangements comprised of generally convex base members arranged to engage the ground at their extremity, or pivot area. However, the invention could equally be realised using any form of pivoting arrangement including mechanical couplings, parabolic base members, conical base members etc.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

The invention that may be claimed is described in the following novel arrangements, either singularly or in any combination thereof:

1. A therapeutic device comprising:
a cradling portion arranged to cradle the head of a user;
a pivoting arrangement provides a pivot area spaced away from the cradling portion and allows the cradling portion to pivot about more than one axis, such that in use the user must effect a balancing action to maintain the position of their head.

2. A therapeutic device according to claim 1 wherein the pivot area is spaced away from the cradling portion by a distance of 2 to 8 centimetres.

3. A therapeutic device according to claim 1 wherein the pivot area is spaced away from the cradling portion by a distance of about 4 to 5 centimetres.

4. A therapeutic device according to claim 1 wherein the pivoting arrangement comprises a generally convex surface of the device.
